(19) United States
(12) Patent Application Publication
(10) Pub. No.: US 2005/0091080 A1
(43) Pub. Date: Apr. 28, 2005

(54) System and method for managing liability insurer healthcare claims

(76) Inventor: Carl G. Biats JR., Jefferson, OH (US)

Correspondence Address: LEE G. MEYER, ESQ.;MEYER & ASSOCIATES, LLC, 17462 E. POWERS DRIVE, CENTENNIAL, CO, 80015-3046, US

(21) Appl. No.: 10/694,120

(22) Filed: Oct. 27, 2003

(51) Int. Cl. G06F 17/60

(52) U.S. Cl. 705/2

(57) ABSTRACT

A system and method for managing liability insurer's healthcare claims, allows liability insurers, such as property and casualty insurers, who have no direct policy relationship with patients for whom they become financially responsible, to take advantage of healthcare provider “rate regulations,” and “healthcare management,” including incentives, heretofore only available to healthcare insurers from healthcare providers within an “active network.” A system administrator manages clamant healthcare claims from member passive network healthcare providers for member liability insurers that become financially responsible for these claims as a result of the actions or inactions of their liability policyholders. The liability insurer members within the insurer network are in contractual relationship with the system administrator who is in contractual relationship with member healthcare providers of the passive healthcare provider network such that when a provider of healthcare product or service submits a claim, for which a system liability insurer member is financially responsible, the system administrator validates the claim as falling in the system; applies the provider network rules; and applies provider coverage rules to determine the level of coverage by the member liability insurer for the claim. Based on this determination, that portion of the claim covered by the member liability policy the Claimant is paid by the system administrator. In another aspect, an Allocation Fund is provided to pay claims where more than one system liability insurer may be liable for the claim.

### BACKGROUND OF THE INVENTION

1. Field Of The Invention

The present invention relates generally to a system and method for managing claims of patients with healthcare providers, outside active healthcare networks; and, more particularly, to a system and method for attaining acceptance of negotiated rates and participation in healthcare management initiatives by healthcare providers for liability insurer Claimants.

2. Description of Related Art

The cost of healthcare in recent years has escalated far beyond the rest of the economy. There are a couple of factors, which are responsible for this unprecedented rise in cost. First, the healthcare expectation of the standard patient has increased substantially. That is, patients expect more comprehensive and better healthcare in all aspects of their lives. Second, the ability to provide this standard of care has become increasingly more expensive with the advent of highly trained specialists, new technologies, better pharmaceuticals, and more expensive healthcare facilities. For example, CT scans machines and MRIs run in the hundreds of thousands dollars and are considered “run of the mill” diagnostic tools for the average practitioner.

In addition, the specialization and number of healthcare providers required to meet this increasing demand has also increased. For example, healthcare specialists in the area of cardiovascular medicine, orthopedics, nephrology, and even physical therapy and occupational therapy have become the norm. Since insurance covers most direct “healthcare”, insurance providers have had to keep up with the ever expanding service providers, as well as the burgeoning costs.

The standard healthcare insurance involves a contractual relationship between the insured patient/beneficiary and the insurer to form a “healthcare” insurance policy. In accordance with the terms of this healthcare insurance policy, the policyholder and those covered, such as a family, are the beneficiaries. These policies cover everything, from routine healthcare to office visits, to diagnostic procedures, to hospitalization, to prosthesis depending upon the coverage. In a typical policy, a patient/beneficiary receives healthcare service or products from a healthcare provider and then, the healthcare provider bills the insurance company directly for the healthcare products and/or services provided to the patient/beneficiary. The amount that the insurer pays the healthcare provider for the services or products provided is determined by the policy between the insurer and the patient/beneficiary. Any cost not covered by the insurer under the policy is the responsibility of the patient/beneficiary.

Under these healthcare policies, there is no contractual relationship between the healthcare provider and the insurer. Thus, in the traditional healthcare industry, most products and services provided to a patient/beneficiary are paid for in accordance with an insurance contract between the insured beneficiary and the insurer. Because of the myriad of insurance policies and coverage available, insurer's base payment for products and services is in compliance with thousands of complex rules as set out in the policy. These rules govern everything, from basic coverage to medical necessity, and even healthcare products such as crutches.

In an attempt to standardize healthcare coverage, as well as try and cope with the complexities and the ever-increasing cost of healthcare, insurers have put together various plans to provide differing levels of care for their insured beneficiaries. Many insurers have instituted alternative healthcare coverage, which involves an “active network” of healthcare providers who are contractually bound directly with the insurer. Thus, if the patient/beneficiary, in accordance with one of these plans, seeks healthcare attention inside this “active network,” the insurer covers certain products and procedures under the policy, based upon the terms of this contract with the healthcare provider.

For example, HMOs have been organized in an attempt to reduce health management costs by employing healthcare providers on a more or less exclusive basis. PPOs have also been organized wherein a provider within the “active network” contractually agrees with the insurer to certain rates for specific services for patient/beneficiaries within the specific plan. Thus, beneficiaries, who pay premiums in PPOs, are given a discount if they stay with providers within the “active network.” If they seek care outside the “active network,” the insurer still covers the healthcare, but at a substantial penalty, such as 80%-20% coverage split. In addition, there are various levels of deductibles and various insured groups such as employers and the like.

The advantage of these “active networks” to healthcare service providers is a volume of business called “steerage,” which means that patient/beneficiaries of insurance policies within these active networks are “steered” to the “active network” member healthcare provider to obtain the financial benefits in both service and product rates. In this manner, the healthcare provider agrees to be “managed” and provide services at an agreed upon rate, in consideration for insurance company's “steering” patient/beneficiaries to these providers.

Thus, not only are there rules regarding specific policy coverage, which govern the payment relationship between the insurer and the patient/beneficiary, but also there are complex rules, which govern the relationship between the healthcare provider and the insurer under these “active network” plans. These rules fall into three categories: General Coverage (GC), Health Plan Coverage (HPC), and Specific Payment Criteria (SPC). GC rules generally define when health insurance coverage will apply to an insured patient. GC rules include information such as whether the patient has insurance, the carrier, the identification number of the beneficiary, and the like. HPC rules define what type of coverage is available to the covered patient beneficiary. HPC rules include information regarding the specific health plan in which the patient/beneficiary is enrolled and the like. HPC rules also include co-payment information, deductible information, and authorization information. SPC rules define the specific scope of the coverage available to the covered Claimant. SPC rules include information regarding whether, in the judgment of the insurer, the product or service being provided to the patient/beneficiary, or the amount of the product, is appropriate and whether the product or service should be paid for as a benefit to the beneficiary under the policy. This is so called managed healthcare.

Currently, GC information is typically available to beneficiaries, individuals, and companies that provide healthcare products and services to the Claimant. This facilitates the application and compliance with the GC rules. HPC information, however, is not currently available to beneficiaries and providers in its entirety. This hinders the application of and compliance with the HPC rules. This, in turn, leads to delays and confusion in obtaining authorization of benefits. In addition, the little HPC information that is available is often inconsistent and too general. SPC information is also not typically available to providers and patient/beneficiaries. This hinders the application of and compliance with the SPC rules. This, in turn, leads to delays in reimbursing the provider or the beneficiary for covered healthcare. The hindrance in the application of and compliance with the rules poses an obstacle for the beneficiary to quickly and efficiently obtain healthcare products and services that are covered by the insurer. Thus, web-based database information flow between the healthcare provider and the insurer have become commonplace.

In addition, automatic or computerized, application of certain of these rules has been applied to, for example, healthcare administered through the pharmacy benefit. That is, automatic compliance with the rules is available for beneficiaries buying drugs or other prescriptive devices from providers. This application, however, is relatively straightforward. The lack of such a system for the medical benefit, and ancillary healthcare administered under the medical benefit, led to an increase in manual claim processing and longer billing cycles for components of the healthcare industry that administer the medical benefit. As one can readily imagine, with the myriad of providers and the myriad of insurance plans, administration of these healthcare insurance plans becomes a monumental task.

A system, for healthcare payment and compliance, applicable to all healthcare benefits, was developed. This system facilitated compliance with rules governing coverage by insurers for all healthcare benefits provided to a patient/beneficiary by a provider, including those providers in “active networks.” Many of these systems both, automated and otherwise, were developed specifically to assist in the administration and management of the interrelationship set forth by contracts between the policyholder and the insurer, as well as the “active network” healthcare provider and the insurer.

Many years ago, Medical Mutual of Ohio developed one such system. This system set up an automated clearinghouse, which included providers in managed healthcare, “active network” plans. In accordance with this system, the contract (policy) is initially entered into between the insurer and the beneficiary for healthcare benefits. The system manages the healthcare provider invoice in accordance with the rules of the policy as previously set forth. The system identifies such things as double billing, billing by different providers for the same treatment and the like. Once the benefits summary is cleared, payment is made to the provider(s) entitled to payment for services rendered under the coverage of the policy. In PPO systems or other “active network” systems the second contract between the insurer and healthcare providers within the “active network” is also managed. In administering these “active networks” a second degree of management complexity is overlaid on the first as previously described.

The insurer applies the “active network” rules, in accordance with the contract directly between the healthcare provider and the insurer/payor. The applicability of “active network” rules to beneficiaries seeking care within the “active network” based upon the schedule of accepted services and/or products, rates for those services and/or products, as well as policy rules for the beneficiary under the healthcare policy is determined. The “active network” healthcare provider invoices are “filtered” or “cleared” against policy and the schedule of accepted services and/or products, rates for those services and/or products, applied. In addition, all co-pays and non-covered services and products are excluded along with double invoices and the like.

Thus, in accordance with this system, the claim is managed based upon two sets of contractual relationships directly with the insurer. One with the healthcare provider and the other with the policyholder/healthcare coverage beneficiary. Other insurers have adopted administration programs similar to that of Medical Mutual of Ohio to administer both, policy requirements, and “active networks” in the healthcare field.

There are numerous of these insurer-administered systems. For example, specific computer program and automated administration system have been employed because of the ever-increasing complexity of the healthcare insurance field. As mentioned previously, both, the standards of care and the care options have made administration of healthcare insurance a complex data intensive proposition. A recent example of this type of system is Kessler et al., which discloses a healthcare payment and compliance system in publication US2001/0034618 A1 published Oct. 25, 2001. In accordance with this system, healthcare providers in active networks submit invoices for the insurers to apply both, the policy rules and the active network rules, to act as a clearinghouse for payment, i.e. to account for transactions, which relate to the insurer's contract with the patient/beneficiary, as well as the insurer's contract with members of the “active network.”

In healthcare insurance, the insurer protects the policyholder and the direct beneficiaries (family in most cases) from financial expense due to illness, disease, hospitalization, accident, and the like. In this type of insurance, there is direct contractual relationship between the policy eligible beneficiary and the insurer. This type of insurance represents, however, only a small percentage of the policies written. By far, a larger percentage involves “liability insurance” wherein the insurer agrees to indemnify the insured's incurred financial liability for certain acts, such as negligence or omissions. This includes healthcare for an injured party, which is separate and apart from the standard healthcare insurance coverage.

This type of “liability insurance,” which carries personal injury protection, is prevalent in most auto (casualty) and property coverage. Examples are standard auto insurance policies, homeowner policies, renter policies, business activity policies, business property policies, and the like. For example, automobile insurance companies have policies, which protect their insured drivers against liability for personal injury to third parties in respect to automobile accidents and or their policyholders from loss due to uninsured motorists. Likewise, homeowner carriers insure their policy holders against personal injury liability associated with accidents on the insured premises.

Because the injured third party is not in a contractual relationship with the insurer, they are able to obtain medical attention at any healthcare provider and the policy terms do not limit the kind of care available or the facilities, which can be used. Further, payment is predicated upon liability of the responsible insured and therefore the responsible insurer must be determined. In many cases assessment of liability cannot be determined unequivocally, and one or more insurers may be liable for the medical costs associated with a particular mishap. In no fault states the difficulty in determining ultimate liability is magnified.

There are, therefore, many insurance companies that are responsible to their insured for medical expenses incurred by third parties, who are not direct beneficiaries of the policy. The extent of the coverage is predicated upon the limits in the policy and the types of acts protected. When the culpable acts of the insured (including those related to ownership of property) result in personal injury to others, then the insurer, in accordance with the policy terms and limits, covers the property loss and medical expenses of the injured third party(s).

Since the third party patient is not the direct beneficiary, and, therefore, has no direct contractual relationship with the insurer, the insurer cannot require, as a condition of policy payment, that the injured third party(ies) seek medical attention with a particular healthcare provider. Thus, the “active network” concept of “steering” a patient to a particular healthcare provider is not available; and, likewise, the managed rates for services and products associated with healthcare “active networks.”

Healthcare providers, and especially hospitals, emergency rooms, and emergency care clinics, therefore, cannot rely on this sustained patronage in treating personal injury covered by liability insurance policies. Claims submittal, especially by these institutions, for treatment of third parties' injuries, for which the liability insurers' insured, are responsible, is a random, lengthy, and complicated process. The rates, therefore, for these services, are oft times greatly elevated to account for lengthy payment cycles and unpaid claims. In many cases, the injured third party is required to pay for these services and then be reimbursed by, for example, judgments against the insured at greatly elevated costs, i.e. the third party injured is forced to become a judicial plaintiff to recover.

It would therefore be advantageous to have an administrated healthcare provider system, which would allow these liability carriers the same “active network” advantages of rates and managed healthcare, even though the insurance carrier does not contract directly with the healthcare provider, and has no control over choice of healthcare by the patient, because the patent is usually not the beneficiary of the policy.

### SUMMARY OF THE INVENTION

In accordance with the invention, a system and method for managing healthcare claims, for which liability insurers are financially responsible, is provided. The system allows liability insurers, such as property and casualty insurers, who usually have no direct policy relationship with patient/Claimants, for whom they become financially responsible, to provide healthcare, “rate regulation,” and “healthcare management,” including incentives, heretofore only available to insurers from healthcare providers within an Active Network.

The system comprises a System Administrator, a Healthcare Provider member of a Passive Healthcare Provider Network, and a Liability Insurer member of a Liability Insurer Network. The System Administrator enters into a relationship with at least one Liability Insurer member, who is indirectly responsible for payment for Healthcare services and products for patients as a result of the Liability Insurer's policy obligation (Coverage) to cover certain financial liabilities of their insured. In one aspect, these Liability Insurers, who are the members of, and form the Liability Insurer Network, vest claim handling for such Claimants in the System Administrator. In addition the Liability Insurers guarantee payment to the System Administrator of claims settled in accordance with the insurance Policy Rules (Coverage terms) and the rules of the Passive Healthcare Provider Network. (Provider Network Rules).

The System Administrator also enters into a relationship with certain Healthcare Providers who are members of the Passive Healthcare Provider Network, that are not directly obligated to the Liability Insurers in the Liability Insurer Network. These member Healthcare Providers submit claims to Liability Insurers for Healthcare of Claimants for whom the member Liability Insurers are financially responsible under the Coverage of the Policy Rules. These Healthcare Providers, who form the Passive Healthcare Provider Network, agree to certain rates and management incentives (Provider Network Rules) for Healthcare provided to Claimants for whom the Liability Insurers in the Liability Insurer Network have financial Healthcare responsibility. The Healthcare Providers, who are members of the Passive Healthcare Provider Network, agree to be bound by the Network Rules of the Passive Healthcare Provider Network in consideration for a guarantee by the Systems Administrator of prompt payment and reduced administration costs.

Thus, the Systems Administrator contracts with member Healthcare Providers who agree to charge negotiated rates and participate in medical care management incentives (Provider Network Rules) to form a Passive Healthcare Provider Network. This Passive Healthcare Provider Network provides medical services and products (Healthcare) to persons seeking medical care (Claimants), wherein one or more Liability Insurers in the Liability Insurer Network is at least partially liable for payment for the Healthcare. By becoming a member of the Passive Healthcare Provider Network and agreeing to be bound by the Provider Network Rules, the Healthcare Providers receive certain considerations which include, but are not limited to, prompt payment, expedited processing of invoices, and the like.

In accordance with the instant invention, a “managed healthcare” system is provided for Liability Insurers, who are participants in a Liability Insurer Network. Healthcare Providers, who are members of a Passive Healthcare Provider Network formed in a contractual relationship with the System Administrator, provide managed Healthcare to Claimants. The Passive Healthcare Provider Network is formed by a relationship between the System Administrator and individual member Healthcare Providers, and applies to Claimants entering the Passive Healthcare Provider Network as a result of an occurrence for which an insured, usually other than the Claimant, is financially responsible. Since the Healthcare Provider cannot rely on “steerage” (the injured party is not the insured and can go to any Healthcare Provider), the consideration for a Healthcare Provider joining the Passive Network is efficiency and prompt payment.

In accordance with the invention, a method for structuring and providing managed care administrative processes, including standard rates, to member Liability Insurers that incur medical expenses for Claimants under their liability policies, is provided. In one aspect, the claim service is provided to the Liability Insurer members and/or the Healthcare Provider member via a communications link using for example, an ASP (Application Service Provider) administered by the System Administrator. The communication links can be dial-up networking, Digital Subscriber Lines, Asymmetric Digital Subscriber Lines, Virtual Private Network, LAN, WAN, cable, IR, radio frequency, cell, Internet, Intranet, and/or satellites. In another aspect, the service is manual.

The System Administrator determines system eligibility and compliance as well as maintaining databases to retain claim transactions and cull redundant or overlapping claims. In one aspect, the System Administrator administers the Policy Rules, as well as the Provider Network Rules. In another aspect, the System Administrator only applies the Provider Network Rules and each member Liability Insurer applies its own Coverage and/or Policy Rules. Advantageously the member Liability Insurer approves the processed claims for payment by the System Administrator.

In one embodiment, Liability Insurer members, such as automotive, home, and the like, are able to obtain negotiated Healthcare rates and managed Healthcare incentives from the Passive Healthcare Provider Network. In another embodiment, liability and subrogation issues as between Liability Insurer members, such as property and casualty carriers, are resolved by use of a claim Allocation Fund, such that Healthcare Provider members of the Passive Healthcare Provider Network, are promptly paid, irrespective of which of the Liability Insurer members in the Liability Insurance Network is ultimately liable for the Healthcare claim.

The method of the instant invention comprises the steps of: (1) receiving a claim for a Claimant soliciting/receiving Healthcare from a Healthcare Provider member within the Passive Healthcare Provider Network; (2) establishing eligibility of the claim (3) applying the Network Rules associated with Passive Healthcare Provider Network to the claim; (4) applying the Policy Rules associated with Liability Insurer Network to the claim; (5) determining the level of liability by each Liability Insurer within the Liability Insurer Network; (6) processing payment for the claim.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. These drawings form part of the present specification and are included, without limitation, to further demonstrate certain embodiments. These embodiments may be better understood by reference to one or more of these drawings in combination with the detailed description of specific embodiments presented herein.

FIG. 1 is a diagram illustrating the elements of one embodiment of the managed Healthcare system of the instant invention;

FIG. 2 is a diagram illustrating the elements of another embodiment of the managed Healthcare system of the instant invention utilizing a claim Allocation Fund.

FIG. 3 is a functional flow of a claim processed through the system of the instant invention in accordance with one method.

### SYSTEM NOMENCLATURE AND DEFINITIONS

As used herein, the following terms will have the meanings hereinafter set forth. Alternative definitions for the listed terms will be apparent to the persons skilled in the relevant art(s) based on the discussion contained herein, and fall within the scope and spirit of embodiments of the invention.

The term “Healthcare” is generally used to refer to the provision of Healthcare Products and Healthcare Services, including Ancillary Healthcare. “Healthcare Services” includes, but is not limited to, medical procedures, mental health treatment and therapy, hospital services and stays, physician visits, nursing, home-based health-related services and other medical attention. “Healthcare Products” includes drugs, medical supplies, medical products, and medical devices. “Ancillary Healthcare” means coverage for products and services that are ancillary to the medical service or product. Examples are durable medical equipment, internal nutrition, incontinence products, ostomy products, respiratory products, long term injectable drugs, infusion services, home or nursing facility Healthcare services, wound care management services products, diabetes management, disease management, and other specialty Healthcare management services products. “Healthcare Provider” is used to refer to an individual or business entity, which provides Healthcare.

The term “Active Network” is used to refer to a Healthcare Provider program, which provides Healthcare to an individual or a group of individuals by privity relationship between the insurer and the Healthcare Provider, in for example a health insurance plan by which an individual/beneficiary pays monthly premiums to a health insurance company and in return receives Healthcare benefits under the umbrella of the plan. Examples of a health insurance plan using an Active Network include a health maintenance organization (HMO), a preferred provider organization (PPO), or a quality point of service (QPOS) plan.

“Passive Network” is used to refer to a program wherein Healthcare Providers provide Healthcare for Claimants who are not Healthcare insurance beneficiaries, but receive Healthcare as a result of a liability insurance policy in accordance with a contract. “Liability Insurer” means an insurer, such as property and casualty insurer, who is not directly responsible to the policy Claimant for normal Healthcare needs, but may become financially obligated for the Healthcare expenses of the insured and/or a third party, to whom the insured may become liable, solely as a result of a liability related claim under the policy.

“System Administrator” means an entity that administers the system and method;
enters into a relationship with members of the Passive Healthcare Provider Network; and, enters into a relationship with members of the Liability Insurer Network. “Insurer”, as used herein, can include insurance companies, third party administrators, insurance intermediaries, government entities, insurance funds, and the like. “Liability Insurer Network” means a group of member Liability Insurers, who are financially obligated to their insured for the Healthcare expenses related to claims against their liability policy(s). These members of the Liability Insurer Network, such as property and casualty insurers, are in a contractual relationship with the System Administrator who provides at least partial administration of Passive Healthcare Provider Network claims under Policy Rules as well as the Provider Network Rules. “Passive Healthcare Provider Network” means a group of member Healthcare Providers that are contractually bound to and/or otherwise associated with a System Administrator for the benefit of Liability Insurers in a Liability Insurer Network, who are liable for Healthcare as a result of the liability of their Policyholders.

The term “Policyholder” is used to refer to an individual who receives the benefits of a liability insurance policy (directly or indirectly), such as auto or property. “Claimant” as used herein is a party who requires Healthcare as a result of an occurrence (such as an automobile accident) for which the Liability Insurer is financially responsible to the Policyholder as a result of a liability insurance policy. A Claimant may be a third party or the Policyholder, depending upon the terms of the policy.

The terms “Coverage” or “Cover” are used to refer to the financial liability of a Liability Insurer for Healthcare provided to a Claimant. This Coverage can be determined within the inventive system by the Liability Insurer or the System Administrator. There can be varying levels of coverage. A Liability Insurer can be liable for the entire value of the claim, be jointly or proportionately liable with another Liability Insurer, or liable only for a portion of the entire claim.

The term “Policy Rules” refers to a group of contract and other terms that are applied by a Liability Insurer, as determined by the policy, to determine the type and level of Coverage owed to a Claimant for provided Healthcare. The Coverage for Healthcare is typically determined by applying Policy Rules against the liability of the Policyholder for the claim. These rules typically take into account a wide array of information including the type of liability plan, the disease, or condition of the Claimant, etc. The rules can include GC rules, HPC rules, and SPC rules, “formulary rule,” “utilization rule,” “economic outcome rule,” “healing outcome rule,” “protocol rule,” “authorization rule,” “deductible rule.” The term “Provider Network Rules” as used herein refers to the rates and managed incentives of the Passive Healthcare Provider Network.

“Allocation Fund” means an account, provided by some, but not necessarily all, member of the Liability Insurer Network for the temporary reconciliation, as between member participating in the claim Allocation Fund, of disputed claim financial liability of their respective insured and a clearing house for allocation, as between these members, of the final allocation of liability. “Allocation Fund Rules”, as used herein, refer to protocol, usually applied by the System Administrator in allocating initial financial responsibility between potentially responsible participating Liability Insurers within the Liability Insurer Network.

The term “HCPCS” is used to refer to Healthcare Product Code System. This is a coding scheme promulgated by Medicare for the purpose of identifying Healthcare products. HCPCS codes are rather general and do not distinguish products having different attributes, such as brand or material. The term “SKU” is used to refer to a Stock Keeping Unit. This is an alternative coding scheme used to identify products. The term “NDC” is used to refer to a National Drug Code. This is an alternative coding scheme used to identify products. The term “UPC” is used to refer to a Universal Product Code. This is an alternative coding scheme used to identify products.

The term “HIPAA” is used to refer to the Health Insurance Portability and Accountability Act of 1997. This act passed by Congress was designed to enable the development of standardization and growth of new efficient systems technology in Healthcare.

### DETAILED DESCRIPTION OF EXEMPLARY EMBODIMENTS

In accordance with the invention, there is provided a system and method for managing and administrating “Healthcare related” claims from Claimants and/or Healthcare Providers under Coverage of a liability policy issued by a Liability Insurer in the Liability Insurer Network. According to the system and method for managing Liability Insurer Healthcare claims, a Claimant receives and/or solicits Healthcare from at least one Healthcare Provider member of the Passive Healthcare Provider Network to generate a Healthcare related liability claim which is Covered by the liability policy of at least one Liability Insurer member in the Liability Insurer Network.

Thus, the system and method of the instant invention provide the member Liability Insurer, within the Liability Insurer Network, the ability to provide Claimants with a freedom of choice as to Healthcare Providers, with the efficiency of procuring Healthcare under Passive Network contracts, which prohibit Healthcare Provider members within the Passive Healthcare Provider Network from billing the Liability Insurer in excess of amounts as provided by Provider Network Rules. Issues regarding claims coding, payment and documentation are resolved as between the claiming Healthcare Provider member within the Passive Healthcare Provider Network and the System Administrator. Thus, the member Healthcare Providers within the Passive Healthcare Provider Network or Claimants submit claims directly to the System Administrator for rules and Coverage processing.

In one embodiment, the instant invention facilitates initial compliance with Policy Rules and Provider Network Rules by a member Healthcare Provider even prior to administering Healthcare to a Claimant. In accordance with this embodiment, there is proven a web-based database to initially determine compliance with the Policy Rules. This aspect is aimed at simplifying and accelerating the process of providing Healthcare to Claimants and insuring prompt reimbursement to Healthcare Providers by Liability Insurers through the System Administrator.

In another embodiment of the present invention, a Liability Insurer provides its Policy Rules to the System Administrator. Subsequently, a Claimant solicits Healthcare from a Healthcare Provider, who is a member of the Passive Healthcare Provider Network. The System Administrator applies the Policy Rules to the claim to determine the level of Coverage. Based on this initial determination, the Healthcare Provider can automatically bill the Liability Insurer for the portion of the value of the claim Covered by the Liability Insurer through the System Administrator. The Healthcare Provider can then provide the Healthcare to the Claimant. The Healthcare Provider can also automatically bill the Claimant for the portion of the value of the claim not Covered by the Liability Insurer. The Healthcare Provider member can automatically receive payment for the Healthcare from the Liability Insurer of approved claims by way of the System Administrator.

In accordance with the instant invention, the Provider Network Rules include, for example, protocol rules, healing outcome rules and economic outcome rules. The applied Provider Network Rules further include formulary rules, utilization rules, authorization rules, and deductible rules. In another embodiment of the present invention, future claims are automatically processed based on an initial approval of Coverage by a Liability Insurer. In another embodiment of the present invention, upon application of the provided Policy Rules, the system of the present invention converts the product codes submitted by the Healthcare Provider member to more specific product codes. The converted product codes are then provided to the Liability Insurer.

In accordance with the present invention, the system is applied towards Ancillary Healthcare as the provision of Healthcare, including: durable medical equipment, enteral nutrition, incontinence products, ostomy products, respiratory products, injectable drugs, infusion services, home Healthcare services, wound care management, diabetes management, disease management, health condition management, and other specialty Healthcare management.

Embodiments of the present invention include an Application Service Provider (ASP) Healthcare Provider model and a stand-alone application program, which allows member Healthcare Providers to facilitate their own compliance with Policy Rules and/or interact with Liability Insurers to administer claims under their own Policy Rules. One advantage of this aspect of the invention is that the Healthcare Provider member can tentatively verify the Policy Rules to determine Coverage online, which results in the immediate provision of Healthcare service to the Claimant. This also results in the assurance that a Healthcare Provider member will be reimbursed for Covered Healthcare subsequently provided to the Claimant. This is beneficial to both the Claimant, and the member Healthcare Provider, as it affirms that neither the Healthcare Provider member nor the Claimant will unknowingly be left liable for the value of the provided Healthcare.

Another advantage of the present invention is that the member Healthcare Providers for the provided Healthcare can bill the member Liability Insurer directly through the System Administrator. Further, the member Liability Insurer can automatically authorize the payment of the Healthcare Provider member for the provided Healthcare upon verifying liability Coverage of the claim. This is beneficial to the Claimant in the process of obtaining Healthcare and it eliminates the confusion as to the entity liable for the provided Healthcare. This is beneficial to the Healthcare Provider member as it reduces the burden of creating and sending a bill to the member Liability Insurer. This is beneficial to the member Liability Insurer as it allows for quick and timely accounting assessments. Further in some no fault states; priority of liability in accordance with statutes is applied.

Another advantage of the present invention is that medical documentation supporting a claim is automatically provided to the member Liability Insurer. This is beneficial to the Claimant and the member Liability Insurer as it allows for quick and efficient determination of Coverage and swift adjudication of a claim, including determination of Liability as between member Liability Insurers and the Claimant. The system also decreases the burden of claim processing and claim adjudication. In addition, member Liability Insurers can obtain more specific information regarding Claimant Healthcare.

Some of the principal aspects of the inventive system and method are summarized as follows: establishing specific rates and managed Healthcare for member Liability Insurers who are not in privity with member Healthcare Providers that treat Claimants; providing an efficient, effective and uniform system of processing Clamant claims from member Healthcare Providers who are not in direct privity with the member Liability Insurers; providing a method of predetermining Claimant coverage under liability policy(ies); and, providing a vehicle for prompt payment of disputed claims among member Liability Insurers to member Healthcare Providers.

In the broader aspect, the system of the instant invention provides a vehicle wherein a System Administrator, for the benefit of the members of a Liability Insurer Network, manages a Passive Network of Healthcare Providers, advantageously. In accordance with this system, the System Administrator contracts with member Healthcare Providers to form at least one Passive Healthcare Provider Network and with member Liability Insurers to form at least one Liability Insurer Network. Claims from Claimants, under Liability Insurer Coverage from a member(s) of the Liability Insurer Network, who receive Healthcare from a Healthcare Provider member, are promptly administered, and disposed of, either by determining ineligibility or payment. This aspect, in and of itself, provides a savings to the Healthcare Provider member in that claims are not handled multiple times for long durations and cash flow is not interrupted by for example claims between Liability Insurers that are not settled.

The members of the Passive Healthcare Provider Network agree to regulated fees and costs as well as specific management rules (Provider Network Rules) in return for this cost savings and efficiency. Thus, the System Administrator agrees to tender prompt payment to a Healthcare Provider member of the Passive Healthcare Provider Network for those claims submitted for which one or more member Liability Insurers in the Liability Insurer Network is financially liable under the Policy Rules.

In operation the System Administrator initially contracts with at least one Healthcare Providers to form at least one Passive Healthcare Provider Network; and, likewise, contracts with at least one Liability Insurer to form a Liability Insurer Network wherein the Liability Insurer is responsible for claims according to the Policy Rules for Healthcare, such as personal injury liability, so that claims are processed and paid in accordance with the Provider Network Rules and the Policy Rules of the system.

A Claimant, to whom the Liability Insurer is believed financially liable, receives Healthcare from member Healthcare Provider(s) in the Passive Healthcare Provider Network. In the case of a third party Claimant, and many Policyholder Claimants, there is no compulsion on the Claimant to seek Healthcare from a specific Healthcare Provider. Thus, the system does not “steer” Claimants to Healthcare Providers as in an Active Network. Rather, Healthcare Providers become members of the Passive Healthcare Provider Network and agree to be bound by the Provider Network Rules to gain efficiency in determining claim coverage and timeliness of receiving payment.

In one aspect, the Liability Insurer applies the Policy Rules to the claim. In another aspect, the System Administrator applies the Policy Rules to determine the level of Coverage, if any, by the member Liability Insurer(s) for the claim. Based upon this determination, the System Administrator processes the claim and pays the approved claim to the member Healthcare Provider in accordance with the Provider Network Rules governing Healthcare in the Passive Healthcare Provider Network. The System Administrator bills the member Liability Insurer(s) for the portion of the value of the claim Covered by Liability Insurer (if more than one) under the Policy Rules.

Advantageously, a third party System Administrator manages the system in consideration for a fee from the members of the Liability Insurer Network and a contractual obligation from a member of the Liability Insurer Network for prompt payment of the Passive Healthcare Provider Network claims which comply with Policy Rules and meet Provider Network Rules.

In accordance with a further aspect, at least some of the members of the Liability Insurer Network create an “Allocation Fund” from which the System Administrator is allowed to pay claims. In accordance with this aspect, if the financial liability, as between participating Liability Insurer members, for a particular claim is disputed, the member Liability Insurers agree to initially split the cost, in some manner, through the Allocation Fund Rules so that the System Administrator can immediately pay the claim of the Passive Network Healthcare Provider. The System Administrator subsequently settles the liability issue among the responsible Liability Insurers within the Liability Insurers Network. In this manner, the Passive Network Healthcare Providers are assured of immediate payment irrespective of actual member Liability Insurer liability.

In accordance with the invention, there is provided a method for processing claims within the system. In the first step either the Healthcare Provider member and/or the Claimant's claims are submitted for review to establish authenticity and determine all information is present for processing, i.e. system compliance. If information is missing, the claim is returned for further handling. Additionally, the claim is processed to determine eligibility and authenticity, i.e. received from a member Healthcare Provider and/or for payment by a member Liability Insurer in an active Liability Insurer Network The claim is returned or purged with notice to the Healthcare Provider if these conditions are not met. When a portion of the financial responsibility resides outside the system, i.e. a Liability Insurer who is not a member of a Liability Insurer Network, then that portion of the claim not Covered by a member Liability Insurer in the Liability Insurer Network is returned to the submitting Healthcare Provider member or Claimant.

Next, the System Administrator applies the Provider Network Rules to the claim in accordance with the Provider Network Rules for the Passive Healthcare Provider Network wherein the Healthcare Provider member providing the claimed Healthcare resides. Adjudication of the claim under Policy Rules is then accomplished. The Liability Insurer or the System Administrator, depending upon the configuration of the system, can accomplish this. In accordance with this aspect, liability Coverage may be parsed as between a number Liability Insurers, (both within and outside the system), and the Claimant. Next, depending upon the configuration of the system, the System Administrator sends the claim for payment approval to the appropriate Liability Insurer in the Liability Insurer Network. The Liability Insurer in the Liability Insurer Network approves the claim and returns it to the System Administrator with payment instructions. Finally, the claim is processed for payment. In accordance with the claim Allocation Fund aspect, during the processing of the claim for payment, the System Administrator checks the claim against the Allocation Fund Rules and the responsible Liability Insurers to determine liability. The System Administrator pays unsettled claims in accordance with the Allocation Fund Rules.

In one embodiment of the present invention, an Application Service Provider (ASP) provides and allows access, perhaps on a subscription or per-use basis, via the global Internet or other connection. That is, the application service provider would provide the hardware (e.g., servers) and software (e.g., database) infrastructure, application software, database files, customer support, and billing mechanism, to allow member Liability Insurer in the Liability Insurer Network to facilitate compliance with Policy Rules for a claim. In another aspect, the System Administrator first determines eligibility and then applies the Provider Network Rules and/or the Policy rules.

System Administrator

In accordance with the invention, the system and method incorporate a System Administrator that is primarily the transaction engine for the liability insurance claims management system. The System Administrator, which may be an arm of one of the Liability Insurers, but is usually independent, enters into an arrangement with each individual Liability Insurer member, to form a Liability Insurer Network. In accordance with this relationship, the insurers within the Liability Insurer Network turn over administration of claims relating to Claimant Healthcare Coverage in accordance with their liability policies.

The System Administrator also has a relationship with individual member Healthcare Providers to form the Passive Healthcare Network. This relationship involves rate regulation and managed care incentives, much like that found in an Active Network, for services and products provided to Claimants under liability policy Coverage of Liability Insurers who are members of the Liability Insurer Network. The claims, which are processed through the System Administrator, are first screened for Coverage, as explained above, and then for compliance with the rates and managed incentives (Provider Network Rules) of the Passive Healthcare Provider Network.

The System Administrator is responsible for collecting from the Liability Insurer members within the Liability Insurer Network, valid claim payments that are timely paid to the member Healthcare Provider as consideration for joining the Passive Healthcare Provider Network. Thus, in one aspect, System Administrator guarantees timely payment in accordance with Policy Rules and agreed upon Provider Network Rules. Because of the nature of the claims, which draw on the Liability Insurer's obligations to financially pay for or indemnify the insured's liability, there is no privity between the Liability Insurer member and the Healthcare Provider member as with an Active Network. Thus, for a Claimant to receive payment from the Liability Insurer, the Liability Insurer's liability for the Healthcare must be established as a result of liability Coverage. For example, in automobile accident (in other then “no-fault states”) the culpable driver is responsible for the injuries to passengers in his vehicle as well as those of the driver and passenger in the other vehicle.

In many cases, this liability is not easily determined, and in comparative negligence jurisdiction, these costs may be parsed out in proportion to each driver's culpability. Thus, when an ASP is used, the Policy Rules can reside on the server or in the Liability Insurer interface database. The Liability Insurer can log on to the ASP and test eligible claims with their Policy Rules and approve the claim for payment by the System Administrator. As can be seen by the skilled artisan, there are many combinations of steps and duties of each of the parties in the system, which are intended to fall within the scope of the invention.

Liability Insurer Network

As set forth previously, Liability Insurers owe a financial duty to their insured for their insured's liability with respect to damage to person, property, reputation, and the like. The instant invention is meant to apply to all Liability insurance wherein Healthcare is involved, including mental Healthcare. In most cases such insurers are designated property and casualty insurers, but in some cases they insure against professional malfeasants, errors, and omissions. Especially in the case of property and casualty insures, there is an element of financial responsibility directly related to the personal, physical, and/or mental condition of the injured Covered party. The most prevalent of these is automobile medical Coverage and property medical Coverage such as injury sustained on a homeowners, businesses, or land owners premises.

As can be readily seen, the injured party may not be in privity of contract with the member Liability Insurer, and in most cases is merely a third party Claimant of the policy between the insurer and the insured. Therefore, an injured third party making a claim for Healthcare against the liability policy is able to go to any Healthcare Provider for Healthcare. Thus, as opposed to “standard healthcare insurance,” where the beneficiary of the policy receives the Healthcare, the insurer has little or no control over the rates and practices of the Healthcare Provider.

The Liability Insurers, who are members of the Liability Insurer Network, agree to promptly reimburse the System Administrator for claims paid in accordance with the Policy Rules and the Provider Network Rules. In one embodiment, certain member Liability Insurers within the Liability Insurer Network provide a claim Allocation Fund, or reimbursement to the System Administrator for those claims where financial responsibility based upon the insured's culpability is a matter of dispute. The actual financial burden is, thus, settled as between these Liability Insurers at a subsequent date and the actual financial obligation adjusted accordingly. In this manner, the System Administrator acts as a clearinghouse for disputed financial obligations as between member Liability Insurers within the Liability Insurer Network. This aspect of the system acts as a further incentive for member Healthcare Providers to submit to Provider Network Rules, since without this clearing arrangement Healthcare Provider claims could remain unpaid for a matter of months, if not years.

Passive Healthcare Provider Network

The Passive Healthcare Provider Network comprises at least one member Healthcare Provider who is in privity of contract with the System Administrator within the system. It will be realized that there may be more than one Passive Healthcare Provider Network within a system depending upon the Provider Network Rules that apply to the member Healthcare Providers in the Passive Healthcare Provider Network. That is, different Provider Network Rules may apply to different Passive Healthcare Provider Networks in accordance with the invention.

The System Administrator, as an intermediary, provides control over Healthcare Providers previously only available in Active Networks. In addition, Liability Insurers, because they indemnify the liability of their insured, are involved among themselves with reconciliation of “fault” of their insured. This makes the ability by a single member Liability Insurer to enter into any managed Healthcare arrangement with a member Healthcare Provider even more difficult. Thus, in accordance with the instant invention, the Liability Insurer Network acts as an agglomeration of member Liability Insurers having a common goal of reducing Healthcare costs, but allowing the vehicle for settling financial liability as between member Liability Insurers for the benefit of the Claimant and Healthcare Provider.

In accordance with the Passive Healthcare Provider Network of the instant invention, Healthcare Providers are networked in a manner similar to Active Networks with Healthcare insurers, but are in privity with the System Administrator. The System Administrator guarantees payments for services provided to Claimants in consideration for which member Healthcare Providers in the Passive Healthcare Provider Network agree to standard rates and management incentives (Provider Network Rules) in submitting billings in accordance with policy claims. In this manner, the Liability Insurers, who participate in the Liability Insurer Network, are guaranteed fixed rates for Healthcare provided by member Healthcare Providers within the Passive Healthcare Provider Network. Likewise, member Healthcare Providers within the Passive Healthcare Provider Network are assured prompt payment, reduced administrative costs, and fewer unpaid bills by being associated with the system of the present invention.

Provider Contracts

The System Administrator and/or a third party contractor, contracts with general acute care hospitals, physicians, and ancillary providers usually in a particular state to provide the Passive Healthcare Provider Network. These provider contracts do not require benefit steerage and ensure that Claimants have easy access to reliable Healthcare. For example, provider contracts might include the following features: combined medical discount from billed charges; hospitals; primary care physicians; other professional providers; and low member Healthcare Provider turnover rate.

Member Healthcare Providers who sign these provider contracts, in accordance with the invention, agree to, for example, accept the Network Provider Rules which include, for example, negotiated rate as payment in full for services provided, and participate in care management initiatives aimed at reducing costs and verifying appropriateness of all procedures. In exchange, member Healthcare Providers receive guaranteed payment and the availability and convenience of electronic claims submission and electronic payment.

In addition, the provider contracts help, for example, with cash flow and efficiency in processing claims. Provider contracts and system reimbursement configurations allow efficient reimbursement for hospitals, depending on the hospitals volume of claims and utilization patterns. The instant system facilitates cost control and utilization management. For example, Diagnosis Related Groups (DRGs) involve a per-case method, which is calculated prospectively, based on the diagnosis, length of stay and age of the patient. The hospital is then paid a specific amount for each inpatient case. Per-Diem (per-day) reimbursement is based on a flat dollar amount times the approved length of stay. According to this method of provider contract payment the System Administrator exercises tight case management controls, which focus on managing the length of stay for inpatient care. The percentage of charges reimbursement plan involves a percentage of Covered charges. Ambulatory Patient Group (APGs) is a prospective reimbursement plan for outpatient cases based upon each outpatient visit. It will be understood that the above represents only examples of Network Provider Rules affected by Healthcare Provider member contracts in accordance with the invention.

The System

3. The system of the instant invention can be manual or employ computer/Internet assisted claim handling and payment. Claims administration is advantageously designed for full access and interface. State-of-the-art programs designed to keep the efficiency of claims processing high while reducing paperwork and manual intervention is advantageous. For example, electronic claims from the hospitals are submitted to System Administrator using a uniform claim format based upon the standards established by the National Uniform Billing Committee. This format is available from both local and national vendors. The systems software is located at the member Healthcare Providers site and performs crucial editing which allows for immediate correction of claims prior to transmission. Electronic claims from other member Healthcare Providers are submitted through a service, which supports the National Standard Format (NSF). In accordance with the invention the ASP containing the administered database can be accessed by a communications link wherein said communication links are selected from dial-up networking, Digital Subscriber Lines, Asymmetric Digital Subscriber Lines, Virtual Private Network, LAN, WAN, cable, IR, radio frequency, cell, Internet, Intranet, satellite, and combinations thereof.

Once received by the System Administrator, all claims are edited for information such as Covered person eligibility. In one aspect, all of the editing is accomplished electronically. In addition to the vast majority of claims submitted electronically and adjudicated automatically, optical character recognition (OCR) can be used for auto-adjudication of paper claims submitted on standard forms, which further enhances the ability to promptly and accurately pay Healthcare Providers.

The claims processing system, in accordance with one embodiment, employs clinical expertise regarding the appropriate reimbursement for Healthcare claims. The System Administrator can perform the following functions in respect to claims for the member Liability Insurers: editing claims for accuracy, completeness, medical necessity, and appropriate utilization of services and procedures; and, validating procedure codes by specific places of service, types of service, age, sex, diagnosis ranges, and Healthcare Provider types of practice.

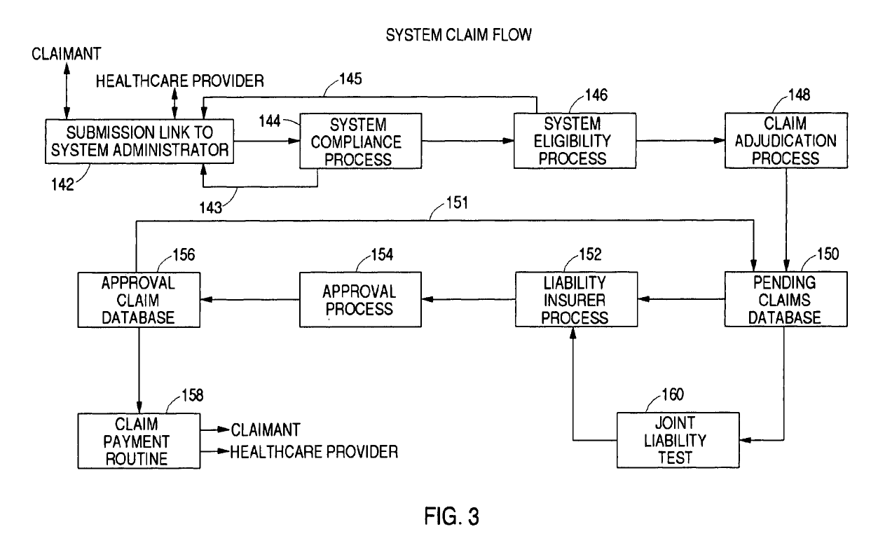

In addition, during the compliance process (See FIG. 3 below) the System Administrator identifies, correctly processes, and designates which Healthcare procedure should not be Covered when the Healthcare procedure is for example (combinations rules processing): incidental services; unbundled services; up-coded service; mutually excluded services; not medically necessary. For example, if the same provider performs two or more surgical Healthcare procedures on the same day, the surgical procedure with the highest allowance will be reimbursed as the primary procedure and all other surgical procedures will be reimbursed as the secondary procedures.

Established System Requirements

Professional Healthcare Providers include, for example, hospitals, primary care physicians, specialists, chiropractors, and physical therapists. These contracting Healthcare Providers agree to a fee reimbursement in accordance with Provider Network Rules for Claimants of Liability Insurer members of the inventive system. They also agree to comply with combination rules processing (bundling. unbundling etc.).

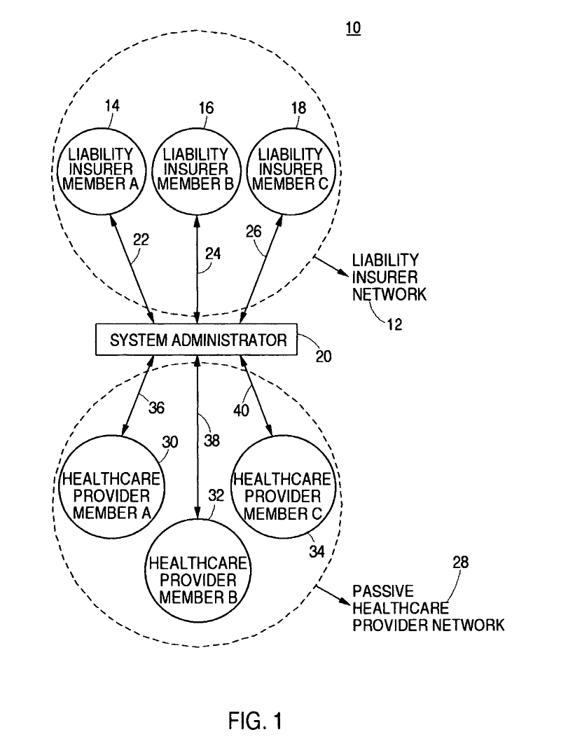

Turning now to the Figures, there is shown in FIG. 1 a system for managing Liability Insurer Healthcare claims by means of a Passive Healthcare Provider Network for member Liability Insurers10. A Liability Insurer Network 12 comprises Liability Insurer member A (14), B (16), and C (18). Each of the Liability Insurer members 14, 16, and 18, independently and individually, contract with System Administrator 20 by means of relationship 22, 24, and 26 respectively, to collectively form the Liability Insurer Network 12 of the instant invention.

The System Administrator 20, within the system, retains eligibility criteria based upon policyholder information for each of the Liability Insurers 14, 16, and 18. In this manner, as will be further described below, a claim moving within the system (see FIG. 3), is able of individual administration under the Liability Insurer's Policy Rules.

Passive Healthcare Provider Network 28 consists of Healthcare Provider member A (30), B (32), and C (34). Healthcare Providers 30, 32, and 34, independently and individually, have contracts with System Administrator 20 by means of relationship 36, 38, and 40 respectively. In accordance with system 10, Healthcare Providers 30, 32, and 34 have access to System Administrator 20 such that claims submitted from the Claimant (not shown), are administered, preferably electronically, by System Administrator 20 in accordance with the Liability Insurer 14, 16, and/or 18, Policy Rules as well as the rate and managed incentive rules (Provider Network Rules) of the Passive Healthcare Provider Network 28. As previously described, the System Administrator 20 can perform a myriad of administration functions to facilitate, classify, regulate, and pay claims for and on behalf of liability insurers within the Liability Insurer Network 12.

In accordance with the system of the present invention, as further described in FIG. 3, the System Administrator 20 maintains a claim data file related to specific Claimants, Policyholders, Healthcare services and/or products provided, and Liability Insurers, to prevent redundancy of payment for services related to the same incident. In this manner, System Administrator 20 provides a clearinghouse for claim disposition, including those claims, which are in need of further determination, information, or processing. This system, thus, saves substantial administrative expense by Liability Insurers within the Liability Insurer Network 12, as well as reducing administrative costs for Healthcare Providers within Passive Healthcare Provider Network 28 by assuring prompt payment of cleared claims. This reduces manpower and accounting paperwork for the Healthcare Provider member in continuing to track outstanding and overdue claims.

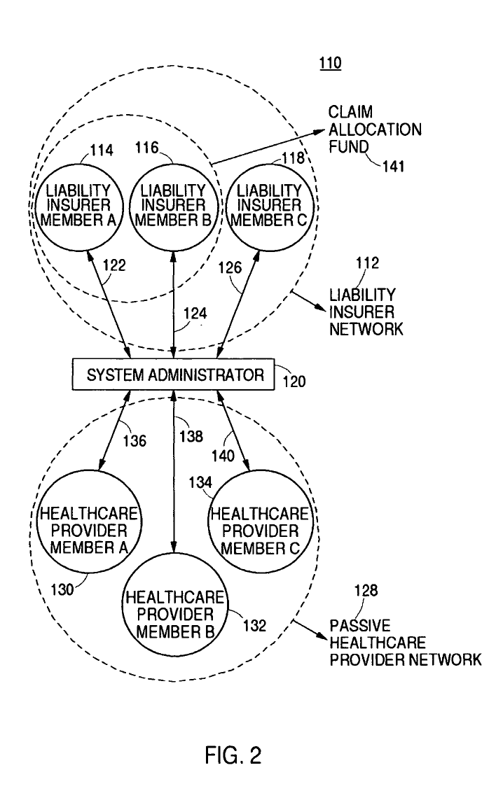

Turning to FIG. 2, there is shown another embodiment of the system of the instant invention. In this embodiment, a system 110 contains a Liability Insurer Network 112 and Liability Insurers A (114), B (116), and C (118). In this embodiment, however, a claim Allocation Fund 141 includes participants Liability Insurer 114 and 116, respectively. System Administrator 120 is in contractual relationship with Liability Insurer 114, 116, and 118 by means of relationship 122, 124, and 126, respectively. Likewise, as in FIG. 1, Healthcare Provider members A (130), B (132), and C (134) contract with System Administrator 120 by means of relationship 136, 138, and 140, respectively.

This embodiment mirrors that of FIG. 1 in all respects, except that the relationship between Liability Insurer 114 and Liability Insurer 116 and the System Administrator 120 is altered by existence of claim Allocation Fund 141. In addition to the contractual relationship of the System Administrator with the Liability Insurers 114, 116, and 118, Liability Insurers 114 and 116 allow System Administrator 120 to tentatively settle multi-Policyholder claims as between Liability Insurer 114 and 116 so that System Administrator 120 can promptly pay claims from Healthcare Providers 130, 132, and 134 within Passive Healthcare Provider Network 128 in accordance with the Allocation Fund Rules.

In this manner, Healthcare Providers within Passive Healthcare Provider Network 128 can promptly dispose of processed claims, which have been paid without the necessity of waiting for a possible judicial determination of ultimate financial responsibility as between Liability Insurer 114 and 116. Upon final settlement or judicial determination of Policyholder financial responsibility for the claims, System Administrator 120 adjusts the accounts of Liability Insurer 114 and Liability Insurer 116 accordingly and tracks the payment as set forth in FIG. 3.

A flow chart of administrative services relating to claim flow in accordance with instant invention is set forth in FIG. 3. Initially, a claim is submitted to the System Administrator from a Healthcare Provider member or a Claimant in submission link 142. The claim is initially tested against a set of criteria to determine if all the system information is contained in the claim needed for processing within the system. This test occurs in system compliance process 144. In the event that one or more pieces of information are incorrect or missing, the system compliance process 144 returns the claim to the Claimant or Healthcare Provider member for re-processing, with noted errors, as shown by link 143.

If the claim is complete, it is reviewed for eligibility in system eligibility process 146 based upon Claimant/Healthcare Provider member information received from system compliance process 144. Within system eligibility process 146 the eligibility of the claim within the system is determined. Specifically, this process determines that the claim was submitted by a Claimant or Healthcare Provider member within the Passive Healthcare Provider Network and, further, that the claim is against at least one Liability Insurer within at least one Liability Insurer Network. The System Administrator advantageously accomplishes this eligibility. If the claim is an eligible claim under the system, the information is forwarded to claim adjudication process 148. If the claim is not eligible, it is returned to the Claimant/Healthcare Provider, with explanation, via link 145.

Within the claim adjudication process 148, the System Administrator applies Provider Network Rules to the claim to determine Covered Healthcare in accordance with the particular Passive Healthcare Provider Network, Provider Network Rules. The processed claim is then stored in pending claims database 150 for processing. Within pending claim database 150 an accounting process is administered to assure that the claim is not overlapping or redundant. In accordance with this aspect, the System Administrator tracks claims from a number of Claimants/Healthcare Providers within a number of the administered Passive Healthcare Provider Networks to assure that a Claimant is not claiming the same claim, either inadvertently or otherwise, through one or more system Healthcare Providers. In some cases, the redundancy will be exact and in others merely overlapping. These claims are culled for further processing within the system and may be send to claim adjusters for determination (not shown), as is well known in the art.

If the claim is not redundant or overlapping, it is sent to the indicated Liability Insurer(s) within the appropriate Liability Insurer Network. In this aspect of the invention, the Policy Rules for the indicated Liability Insurer are applied by the individual Liability Insurer. It will be realized that in another aspect, Policy Rules for all Liability Insurers within administered Liability Insurer Networks can be housed on a server by the System Administrator and applied prior to sending the claim to the specific Liability Insurer process 152. This aspect is helpful when the claim Allocation Fund concept is used, as well as when no fault liability is in play.

In any event, Liability Insurer determines/approves liability and prepares payment instructions based upon Policy Rules within approval process 154. The approval and payment instructions are sent from approval process 154 to approval claim database 156 within the System Administrator and are simultaneously transferred to claim payments process 158 for disbursement to Claimant/Healthcare Provider member in accordance with the original claim. The claim information for paid claims is then transferred from approved claim database 156 to pending claims database 150 to update that database with the “paid” information.

In accordance with another aspect as shown in FIG. 2, a claim Allocation Fund is used for claims for approval in Liability Insurer process 152 as follows. As shown further in FIG. 3, prior to sending the claim from pending claims database 150 to Liability Insurer process 152, a further check is made in joint liability test 160. If the claim is one that is not finally determined and involves more than one Liability Insurer having potential liability for the claim, then the System Administrator appends the claim with a claim Allocation Fund pro ration for each Liability Insurer in accordance with the Allocation Fund Rules. The appended claim is then sent to the appropriate Liability Insurer process 152 for approval. Within joint liability test 160, this claim Allocation Fund claim is retained in the database along with the proportionate allocation of liability/payment that was sent to the indicated Liability Insurer for approval. Once approval is obtained in approved claim database 156, the actual payment for the claim Allocation Fund is transmitted to pending claims database 150 and subsequently to update joint liability test 160. Once the matter of the claim is finally settled/adjudicated, the information in joint liability test 160 is updated and the Liability Insurers involved in the apportioned claim are notified in accordance with the system, as previously described. The System Administrator makes re-adjusted allocation/payment to the various Liability Insurers based upon the portions of claim payment as finally settled/adjudicated.

One skilled in the art will appreciate that the above-described system can be used in various environments other than the Internet. Such alternate communications channels include, but are not limited to, local area network, wide area network, or, as described above, point-to-point dial up connections. Additionally, a ASP may comprise any combination of hardware or software that can offer functionality within the system and/or interface with Passive Network Healthcare Providers.

All of the methods and systems disclosed and claimed herein can be made and executed without undue experimentation in light of the present disclosure. While the methods and systems of this invention have been described in terms of embodiments, it will be apparent to those of skill in the art that variations may be applied to the methods and systems and in the steps or in the sequence of steps of the methods described herein without departing from the concept, spirit and scope of the invention. Various substitutions can be made to the hardware and software systems described without departing from the spirit of the invention. All such similar substitutes and modifications apparent to those skilled in the art are deemed to be within the spirit, scope, and concept of the invention as defined by the appended claims.

1. A system for managing healthcare claims, for which liability insurers are financially responsible, comprising:
a) at least one system administrator in privity, directly or indirectly, with at least one healthcare provider member, and at least one liability insurer member;
b) at least one passive healthcare provider network including said at least one healthcare provider member having a set of network provider rules; and,
c) at least one liability insurer network including said at least one liability insurer member having a set of policy rules wherein said at least one system administrator receives claims, applies said network provider rules, transmits said claim for application of said policy rules, and pays said claim in accordance therewith.

2. The system of claim 1 wherein said policy rules are applied by said at least one liability insurer member.

3. The system of claim 1 wherein said policy rules are applied by said at least one system administrator.

4. The system of claim 1 wherein said system is automated by means of application service provider having communication links among said at least one liability insurer member, said at least one system administrator, and; said least one healthcare provider member.

5. The system of claim 4 wherein said communication links are selected from dial-up networking, Digital Subscriber Lines, Asymmetric Digital Subscriber Lines, Virtual Private Network, LAN, WAN, cable, IR, radio frequency, cell, Internet, Intranet, satellite, and combinations thereof.

6. The system of claim 1 wherein said claim is generated, at least in part, by said a least one healthcare provider member prior to providing healthcare.

7. The system of claim 1 wherein said claim is tested for compliance with the system criteria and then tested for systems eligibility prior to application of said network provider rules.

8. The system of claim 1 wherein said system includes a claim allocation fund.

9. The system of claim 8 wherein said at least on system administrator applies the allocation find rules as between potentially liable liability insurer members to establish initial allocated liability for payment of said claim.

10. The system of claim 1 wherein said system further comprises at least one pending claim database and at least one paid claim database in communication, one with the other.

11. The system of claim 1 wherein said claim is generated, at least in part by a Claimant.

12. The system of claim 1 wherein said claim is generated, at least in part by a member healthcare provider.

13. The system of claim 1, wherein the policy rules include protocol rules; healing outcome rules; and economic outcome rules.

14. The system of claim 13, wherein the policy rules further includes formulary rules; utilization rules; authorization rules; and, deductible rules.

15. The system of claim 1, further comprising: means for converting a first product code submitted with said claim to a more specific product code.

16. The system of claim 15, further comprising: means for providing said more specific product code to the liability insurer.

17. A method for managing claims relating to healthcare provided by a member healthcare provider, for which a liability insurer, within a liability insurer network, is financially responsible, comprising the steps of:
a) receiving a claim for healthcare;
b) applying the network rules associated with a passive healthcare provider network in which said healthcare provider is a member, to the claim;
c) applying the policy rules associated with the member liability insurer network to the claim;
d) processing the appropriate payment of the claim.

18. The method of claim 17 comprising the further steps of establishing compliance and eligibility of the claim.

19. The method of claim 17 comprising determining the level of liability by each liability insurer member within a liability insurer network prior to processing said appropriate payment of the claim.

20. The method of claim 19 wherein a claim allocation fund is used to satisfy the level of financial liability of each liability insurer member for unresolved financial liability using allocation fund rules.

21. The method of claim 17 wherein a system administrator is used to facilitate the steps.

22. The method of claim 17 wherein said method is application service provider based.

23. A method for facilitating compliance with policy rules governing coverage by a liability insurer for healthcare provided to a Claimant by a member healthcare provider comprising the steps of:
b) receiving a liability generated claim for healthcare;
c) applying provider network rules to said claim;
d) determining the level of liability coverage for the claim; and
e) processing payment or authorization to provide healthcare for said claim based thereon.

24. The method of claim 23 wherein said method is application service provider based.

25. The method of claim 24 wherein a system administrator administers said application service provider based method.

26. The method of claim 23 wherein said application service provider based method utilizes communication links selected from dial-up networking, digital subscriber lines, Asymmetric Digital subscriber lines, virtual private network, LAN, WAN, cable, IR, radio frequency, cell, Internet, Intranet, and/or satellites.

27. The method of claim 23 wherein initial financial liability for said covered claim is resolved by use of allocation fund rules applied to a claim allocation fund.

28. The method of claim 23, wherein said claim includes Claimant information; liability insurer information; prescription information associated with the healthcare; injury or wound information associated with the healthcare; and combinations thereof.

29. The method of claim 28, wherein said information associated with the healthcare comprises a HCPCS product code corresponding to the healthcare.

30. The method of claim 29, wherein said HCPCS product code is mapped to a more specific product code.

31. The method of claim 30, wherein said more specific product code is provided to the liability insurer member.

32. The method of claim 23, wherein the rules governing coverage comprise: protocol rules; healing outcome rules; and economic outcome rules.

33. The method of claim 32, wherein the rules governing coverage further comprise: formulary rules; utilization rules; authorization rules; co-payment rules; and deductible rules.

34. The method of claim 23, wherein said authorization step further comprises: initiating the release of the healthcare service from the provider to the Claimant.

35. The method of claim 23, further comprising: automatically processing fulfillment of future claims determined by said authorization step.

36. The method of claim 23 wherein the method is applied to ancillary healthcare.

37. A system for facilitating compliance with policy rules governing coverage by a liability insurer for healthcare provided to a Claimant by a member healthcare provider, wherein the healthcare is administered under provider network rules in a passive healthcare provider network comprising:
a) means for receiving a liability claim for said healthcare;
b) means for applying said provider network rules associated with said passive healthcare provider network;
c) means for applying said policy rules governing coverage by a liability insurer of said claim;
d) means for approving the level of coverage by the liability insurer for said claim; and,
e) means for processing payment for said claim.

38. The system of claim 37, wherein the rules governing coverage comprise: protocol rules; healing outcome rules; and economic outcome rules.

39. The system of claim 38, wherein the rules governing coverage further comprise: formulary rules; utilization rules; authorization rules; and deductible rules.

40. The system of claim 37, further comprising: means for converting a first product code submitted with said claim to a more specific product code.

41. The system of claim 40, further comprising: means for providing said more specific product code to the liability insurer.

42. The system of claim 41, wherein the system is used for ancillary healthcare.

43. The system of claim 37 wherein said system is application service provider based.

44. The system of claim 43 wherein a system administrator administers said application service provider based method.

45. The system of claim 44 wherein said communication links are selected from dial-up networking, digital subscriber lines, asymmetric digital subscriber lines, virtual private network, LAN, WAN, cable, IR, radio frequency, cell, Internet, Intranet, satellite, and combinations thereof.

46. The system of claim 37 wherein said means for approval further comprises determining initial financial liability for said claim by use of allocation fund rules applied to a claim allocation fund.

47. The system of claim 37, wherein said claim includes Claimant information; liability insurer information; prescription information associated with the healthcare; injury or wound information associated with the healthcare; and combinations thereof.

48. The system of claim 47, wherein said information associated with the healthcare comprises a HCPCS product code corresponding to the Healthcare.

49. The system of claim 48, wherein said HCPCS product code is mapped to a more specific product code

50. The system of claim 49, wherein said more specific product code is provided to the liability insurer member.
